(19) United States
(12) Patent Application Publication
(10) Pub. No.: US 2014/0222619 A1
(43) Pub. Date: Aug. 7, 2014

(54) METHODS AND SYSTEMS TO IMPLEMENT A PRIVATE SALE

(71) Applicant: David J. Kamalsky, San Jose, CA (US)

(72) Inventor: David J. Kamalsky, San Jose, CA (US)

(21) Appl. No.: 14/092,811

(22) Filed: Nov. 27, 2013

Related U.S. Application Data
(60) Provisional application No. 61/759,925, filed on Feb. 1, 2013.

(51) Int. Cl. G06Q 30/06

(52) U.S. Cl. CPC G06Q 30/0613
USPC 705/26.41

(57) ABSTRACT

In some examples, a system comprises a memory and at least one module, executing on one or more computer processors, to host an online marketplace for marketplace participants, allow a segmentation of the marketplace into at least one private group for private participants, and receive listings of items for sale exclusively to the private participants.

### CLAIM OF PRIORITY

This patent application claims the benefit of priority, under 35 U.S.C. Section 119(e), to Kamalsky, U.S. Provisional Patent Application Ser. No. 61/759,925, entitled “METHODS AND SYSTEMS TO IMPLEMENT A PRIVATE SALE,” filed on Feb. 1, 2013 (Attorney Docket No. 2043.C16PRV), which is hereby incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright eBay, Inc. 2013, All Rights Reserved.

### TECHNICAL FIELD

This application relates generally to systems, methods and media to implement private group sales, and more specifically to systems, methods and media for the creation, management, and presentation of private group sale listings in online marketplace environments.

### BACKGROUND

Before the advent of online (or electronic) marketplaces, selling used items was done primarily through the placement of advertisements in local newspapers, through swap-meets, or by word-of-mouth. In all of these physical (or real world) marketplaces, sales were typically completed in a face-to-face manner and local communities of interest would sometimes form around categories of items of special interest or character such as used cars, musical equipment, video games, and so forth. With supply and demand varying greatly by geography, the value of items sold or traded would often vary by community, providing those with the right social connections the ability to source and purchase hard-to-find items or even common items offered at significant savings, for example.

As online marketplaces developed, the removal of geographic barriers allowed exciting deals or offerings to become increasingly available to a larger population of buyers. But as a consequence, much of the historical face-to-face social interaction, and the manner in which this can drive sales in the real world, has been lost.

Conventional online marketplaces suffer some further significant drawbacks. These can include a lack of restriction or segmentation of sales with minimal management of online transactions by marketplace participants. Membership in marketplaces has conventionally been conducted on the basis of voluntary sign up, not invitation. Group deals, for example, as opposed to mere guidance and information, have not traditionally been offered online. It is difficult to build trust quickly between online traders, and the existence of fraudulent traders makes this challenge all the more difficult.

### SUMMARY

The present inventor has recognized, among other things, that problems to be solved can include the drawbacks discussed above. The present subject matter can help provide a solution to these problems.

Thus in one example embodiment, a system comprises a memory, and at least one module, executing on one or more computer processors, to host an online marketplace for marketplace participants, allow a segmentation of the marketplace into at least one private group for private participants, and receive listings of items for sale exclusively to the private participants.

In another example embodiment, a computer-implemented method comprises hosting an online marketplace for marketplace participants, allowing a segmentation of the marketplace into at least one private group for private participants, and receiving listings of items for sale exclusively to the private participants.

A further example embodiment includes a non-transitory machine readable medium, including instructions, which when performed by a machine, causes the machine to perform operations including hosting an online marketplace for marketplace participants; allowing a segmentation of the marketplace into at least one private group for private participants; and receiving listings of items for sale exclusively to the private participants.

These and other examples and features of the present systems, methods and media will be set forth in part in the following Detailed Description. This Summary is intended to provide non-limiting examples of the present subject matter—it is not intended to provide an exclusive or exhaustive explanation. The Detailed Description below is included to provide further information about the present systems, methods and media.

### BRIEF DESCRIPTION OF DRAWINGS

Embodiments are illustrated by way of example and not limitation in the figures of the accompanying drawings. Like reference numbers indicate similar elements.

FIG. 1 is a schematic view of private groups in an online marketplace, according to example embodiments.

FIG. 2 is a block diagram illustrating an example embodiment of a system for online marketplace listings in private groups, according to example embodiments.

FIG. 3 is a flow chart of a method, in accordance with example embodiments.

FIG. 4 is a diagrammatic representation illustrating an example machine in the form of a computer system within which a set of instructions for causing the machine to perform a portion of any one or more of the methodologies discussed herein may be executed.

### DETAILED DESCRIPTION

Example methods, systems and media to implement private sales in online marketplace environments are described. In the following description, for purposes of explanation, numerous specific details are set forth in order to provide a thorough understanding of example embodiments. It will be evident, however, to one skilled in the art that the present inventive subject matter may be practiced without these specific details.

In some examples, a private sale system in an online marketplace allows a seller to offer special pricing and promotions to selected groups, and only to those groups. Three example use cases can include consumer-to-consumer, business-to-consumer, and business-to-business selling.

In a consumer-to-consumer example, a large collectables market may exist in an online forum hosted outside a conventional online marketplace environment. Such groups are often highly socialized and tend to sell items at cost or at a discount to people of like interests and passions. The private sale system can be used by private group members who decline to sell goods in conventional online marketplace environments for fear that commercial entities will buy goods with the sole intention of reselling them at a large profit. Likewise, buyers in consumer-to-consumer examples within a private sale system may be willing to pay more for an item if they know the money is going to someone in their social (private) group. Through the employment of a system hosting a private sale environment, a conventional online marketplace can help social groups buy, sell, or trade amongst themselves in a safe marketplace, while in some cases increase the market share of conventional online marketplace in collectables.

In further consumer-to-consumer examples, the use of social pressures within these exclusive groups can guide buyers and sellers toward mutually beneficial transactions in which buyers are appreciative of the intrinsic value of a particular item, brand, or collection, and sellers rely on this demand to price goods or services for sale appropriately.

In business-to-consumer examples, business participants in a private sale environment can establish their own private groups to market goods to their top customers and retain customers by offering targeted discounts, for example. A business seller in such a group can create a group to retain top buyers using incentives and deals. This type of interaction is more market-based than social, but exclusivity and the value of deals can create a “social demand” for wanting to be in the group, and possibly even displaying membership of a group as part of a public profile or social status.

In business-to-business examples, large retailers having big inventories offered for sale in a conventional online marketplace can offer special pricing and incentives to buyers at other businesses. In a more specific example, a large retailer may have a special relationship with another retailer, or the other retailer may have an account in the same online marketplace in which the large retailer participates.

In a further embodiment, a large office retailer, for example, can offer employees of an entity hosting or participating in an online marketplace environment a discount on all products purchased from the office retailer. Private sales groups of the present subject can participate fully in such examples, especially as online social interactions and relationships evolve further to match the strength of traditional relationships in the real world.

Benefits presented by the private sale systems, methods and media of the present subject matter can include segmentation of users and exclusivity. In some examples, sales can be restricted to a subset of buyers. Community-led formation and management of the segment/subset sales is facilitated. Private sale listings may be open or closed as determined by a community, or may be by open invitation to all. Private sale listings can be created, managed and presented as a function of social signals or criteria. Group deals and shopping or consumer power can be encouraged or focused. Trade can occur privately among the members of the private group. This can build trust and reputation, and enhance safety mechanisms and the privacy of users within the group. Invitations can be extended to users outside the group who may have an interest in the trading activities or subject matter of the group.

In some examples, a private sale is a listing published in an online marketplace that can only be accessed by a smaller group of potential buyers. Unlike interest-specific sale sites or invitation-only sale sites, the private sales described herein can inherit standard trust and safety mechanisms of conventional online marketplaces such as seller verification, buyer protection, and the like. The private sales can drive greater buyer and seller social interaction towards mutually beneficial transactions (supply and demand, group buying power to obtain discounts, and the like). In a private sale environment, groups may be self-managed or refuse entry to known bad actors. Similarly, the closed private environment allows for trading among members and keeps valuable inventory within a defined group of people. The private sale environment permits self-segmentation by interest of both buyers and sellers.

In some examples, private sales provide segmentation of users and exclusivity, with community formation and management being left to each segment. Sales are restricted to a subset of buyers. The community may determine whether to limit the community to particular users in various ways (e.g., invitation-only, users apply for permission to join group) as a function of social signals or other criteria. The segment may facilitate group sales or leverage the shopping power of the group to obtain more beneficial terms or non-traditional terms. Trade is allowed privately in, and restricted to, the segment while building trust and reputation in the members of the segment.

In some examples, targeted information or other content can be presented to members of a private group via a mobile device. More generally such information may be presented via an “interface”. An interface can exist in many forms. For example, the interface may interact with a user, in a functional or physical way, and may contribute and/or consume content. The interface may be associated with a device, but not necessarily so. The interface may be mouse driven, voice driven, or touch driven, for example. An associated device might be network enabled, but not necessarily so. The device or interface may be associated with local or proximate processing capability. In some examples, a physical interface may be presented by “smart” glasses (for example, Google glasses). In other embodiments, an interface may be intangible, such as a hologram. In further examples, the interface may be a non-mobile surface, such as a wall, table top, or side of an appliance. In other examples, an interface may be provided in a kiosk, or by a surface or device inside a motor vehicle, for example.

In some examples, targeted information or other content may be associated with a “location determination” of a user. This term includes detecting a user's presence or location. It may involve active sensing (for example, an accelerometer or other sensor) or a passive identification (for example, RFID). Location identification can be used as trigger to present targeted information or other content in an interface.

Targeted information or other content may include “consumable” information or “non-consumable” information (for example, metadata). Consumable examples can be displayed, emailed, pushed, or included in a text message. The information may include tiles, social media, digital data, physical (billboard) embodiments, audio files, commercial art, smart advertisements and so forth.

A “device” is any physical object which is capable of being a communication device or can present an interface. The device may be associated with local computational or remote computational functionality.

In some examples, targeted information may include “ad content”. Ad content may include promotional information which characterizes this information from general content. A “promotion” in ad content need not be tied to commerce, or payment, or a transaction, but will usually be associated with receipt of some kind of value. The value could relate to a good or a service (or hybrid of same).

The presentation of the targeted information may seek to extend on-line user “sessions”. In a multi-device world, the conventional definition of a session is becoming increasingly inapplicable. Viewed more broadly, a session in this disclosure includes the idea that the user is trying to achieve a particular task, with that task potentially spread over multiple devices and extended time period. The user could pick up a session on a different device, or after a lapse of time, and so forth. A user could have many parallel sessions going on simultaneously, for example. A session may include user phases, such as a discovery phase, an exploratory phase, a follow-up phase, and so forth. Sessions may be assessed or tied to a success metric, such as a “Bid-Buy-Offer-Watch-Ask seller question” (BBOWA) metric, for example.

Thus, in some embodiments, a method comprises hosting an online marketplace for marketplace participants; allowing a segmentation of the marketplace into at least one private group for private participants, and receiving listings of items for sale exclusively to the private participants.

In some embodiments, a system comprises a memory and at least one module executing on one or more computer processors to host an online marketplace for marketplace participants; allowing a segmentation of the marketplace into at least one private group for private participants; and receiving listings of items for sale exclusively to the private participants.

In some examples, substantially all the private participants are consumers, and the listings of items for sale are managed at least in part by a consumer participating in the private group.

In some examples, the listings of items for sale are managed at least in part by a business participating in the private group, and wherein substantially all the remaining private participants in the private group are consumers.

In some examples, substantially all the private participants are businesses, and wherein the listings of items for sale are managed at least in part by a business participating in the private group.

In some examples, the at least one module is further to extend an invitation to a marketplace participant to join at least one of the private groups. In some examples, the at least one module is further to provide at least one participant safety feature in the online marketplace, and further to extend the at least one safety feature to private participants participating in the at least one private group.

In some embodiments, a non-transitory machine-readable medium comprises instructions that, when executed by one or more processors of a machine, cause the machine to perform operations described herein.

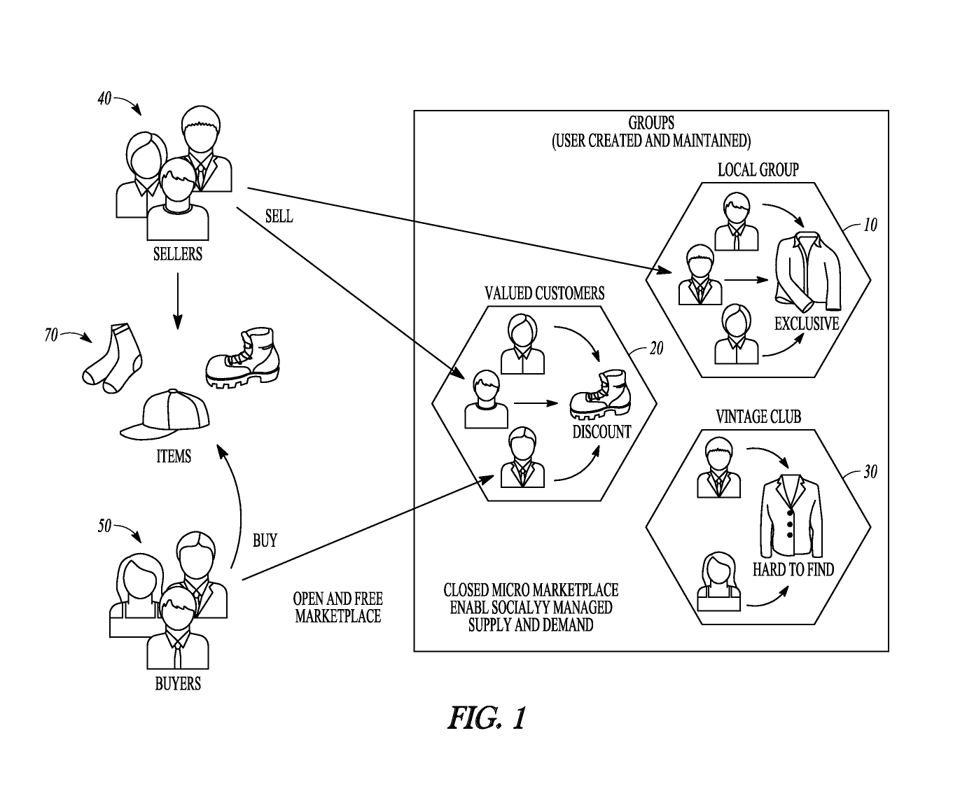

The private sale groups in an online marketplace may exist in multiple forms, as illustrated in FIG. 1 of the accompanying drawings. Marketplace participants (or users) may include, for example, sellers 40 and buyers 50 related to sales of items (goods or services) 70. Other marketplace participants are possible, such as merchants, content providers, advertisers, service providers, and so forth. Other marketplace commodities and environments are possible.

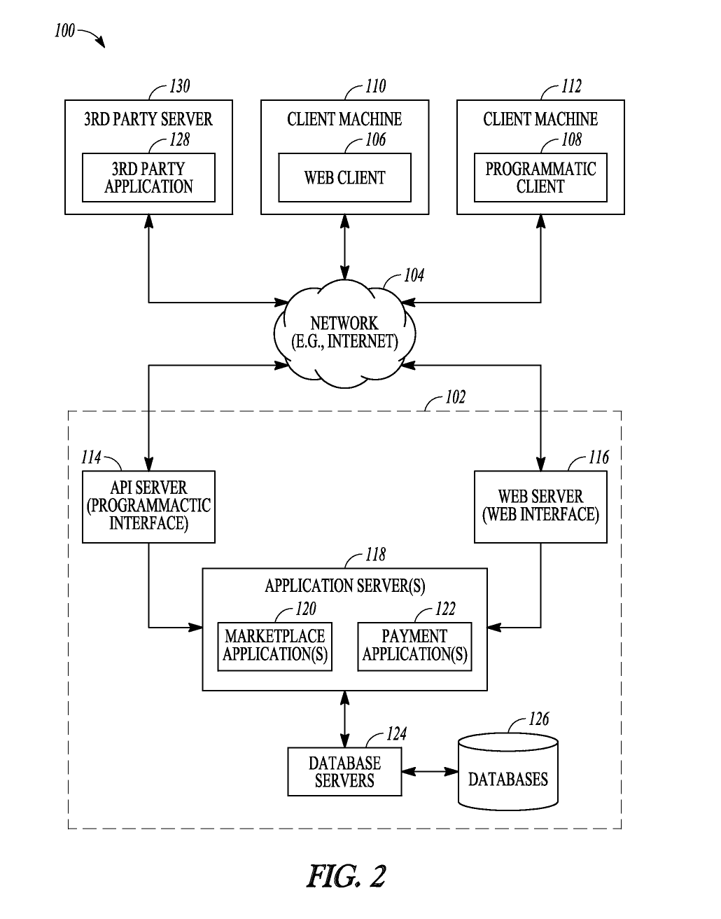

In some examples, private groups such as a local group 10 (for example, consumer-to-consumer participants), valued customers 20 (for example, business-to-consumer, or business-to-business participants), or a vintage club 30 (for example, consumer-to-consumer participants) can be formed. In each group, listings of items for sale can be created, managed and presented in various ways. In this specification, the term “items for sale” includes goods and services. Other items of tangible or intangible nature are possible. The example private groups 10, 20, and 30 can each be implemented by a system 100 depicted in FIG. 2 of the accompanying drawings.

FIG. 2 is a network diagram depicting a client-server system 100, within which one example embodiment may be deployed. A networked system 102, in the example forms of a network-based marketplace or publication system, provides server-side functionality, via a network 104 (e.g., the Internet or Wide Area Network (WAN)) to one or more clients. FIG. 2 illustrates, for example, a web client 106 (e.g., a browser), and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more database servers 124 that facilitate access to one or more databases 126.

The marketplace applications 120 may provide a number of marketplace functions and services to users that access the networked system 102. For example, such functions and services may include hosting an online marketplace for marketplace participants, allowing a segmentation of the marketplace into at least one private group for private participants, and receiving listings of items for sale exclusively to the private participants. Other functions and services may be provided, including the method operations described further below.

The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 2 to both form part of the networked system 102, it will be appreciated that, in alternative embodiments, the payment applications 122 may form part of a payment service that is separate and distinct from the networked system 102.

Further, while the system 100 shown in FIG. 2 employs client-server architecture, the present inventive subject matter is not limited to such architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 2 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace or payment functions that are supported by the relevant applications of the networked system 102.

With above descriptions in mind, any of the machines, repositories, or devices described herein may be used or configured partially or entirely as appropriate to perform one or more of the methods, operations, or functions described herein, or as set forth below in the following operations. Other devices or systems may be employed. Some examples of the present disclosure include methods.

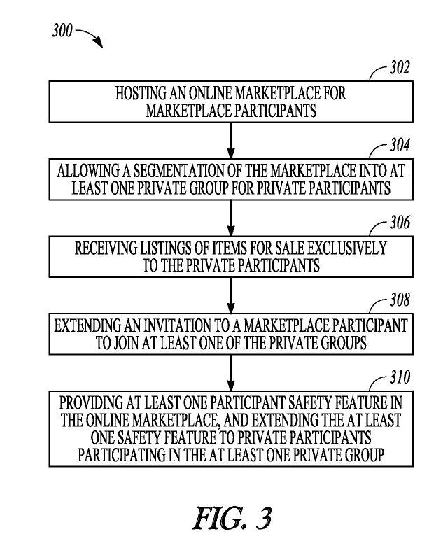

One such method is illustrated in FIG. 3. In this example embodiment, a method 300 includes: at block 302, hosting an online marketplace for marketplace participants; at block 304, allowing a segmentation of the marketplace into at least one private group for private participants; and, at block 306, receiving listings of items for sale exclusively to the private participants.

In some examples, substantially all the private participants are consumers, and the listings of items for sale are managed at least in part by a consumer participating in the private group. In some examples, the listings of items for sale are managed at least in part by a business participating in the private group, and substantially all the remaining private participants in the private group are consumers. In some examples, substantially all the private participants are businesses, and the listings of items for sale are managed at least in part by a business participating in the private group.

In some examples, the method 300 further comprises, at block 308, extending an invitation to a marketplace participant to join at least one of the private groups. The method 300 may further comprise, at block 310, providing at least one participant safety feature in the online marketplace, and extending the at least one safety feature to private participants participating in the at least one private group.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

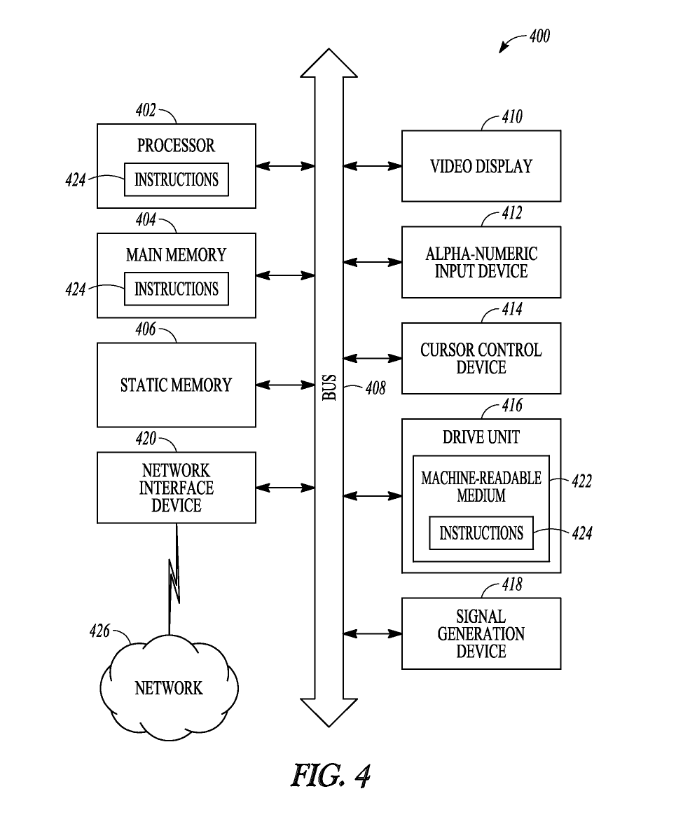

FIG. 4 is a block diagram of a machine in the example form of a computer system 400 within which instructions 424 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processor 402 (e.g., a central processing unit (CPU), a graphics processing unit (GPU) or both), a main memory 404 and a static memory 406, which communicate with each other via a bus 408. The computer system 400 may further include a video display unit 410 (e.g., a liquid crystal display (LCD) or a cathode ray tube (CRT)). The computer system 400 also includes an alphanumeric input device 412 (e.g., a keyboard or a touch-sensitive display screen), a user interface (UI) navigation (i.e., cursor control) device 414 (e.g., a mouse), a disk drive unit 416, a signal generation device 418 (e.g., a speaker) and a network interface device 420.

### Machine-Readable Medium

The disk drive unit 416 includes a machine-readable medium 422 on which is stored one or more sets of data structures and instructions 424 (e.g., software) embodying or utilized by any one or more of the methodologies or functions described herein. The instructions 424 may also reside, completely or at least partially, within the main memory 404 and/or within the processor 402 during execution thereof by the computer system 400, the main memory 404 and the processor 402 also constituting machine-readable media.

While the machine-readable medium 422 is shown in an example embodiment to be a single medium, the term “machine-readable medium” may include a single medium or multiple media (e.g., a centralized or distributed database, and/or associated caches and servers) that store the one or more instructions 424 or data structures. The term “machine-readable medium” shall also be taken to include any tangible medium that is capable of storing, encoding or carrying instructions for execution by the machine and that cause the machine to perform any one or more of the methodologies of the present inventive subject matter, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 424 may further be transmitted or received over a communications network 426 using a transmission medium. The instructions 424 may be transmitted using the network interface device 420 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. Further, the steps recited in any method or process claims may be executed in any appropriate order and are not limited to the specific order presented in the claims. Additionally, the components and/or elements recited in any apparatus claims may be assembled or otherwise operationally configured in a variety of permutations and are accordingly not limited to the specific configuration recited in the specification and shown in the drawings.

As used in this description, the terms “comprise,” “comprises,” “comprising,” “having,” “including,” “includes,” or any variation thereof, are intended to reference a non-exclusive inclusion, such that a process, method, article, composition, or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present subject matter, in addition to those not specifically recited, may be varied or otherwise particularly adapted to specific environments, manufacturing specifications, design parameters or other operating requirements without departing from the general principles of the subject matter.

This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. A system comprising:
a memory; and
at least one module, executing on one or more computer processors, to:
host an online marketplace for marketplace participants;
allow a segmentation of the marketplace into at least one private group for private participants; and
receive listings of items for sale exclusively to the private participants.

2. The system of claim 1, wherein substantially all the private participants are consumers, and wherein the listings of items for sale are managed at least in part by a consumer participating in the private group.

3. The system of claim 1, wherein the listings of items for sale are managed at least in part by a business participating in the private group, and wherein substantially all remaining private participants in the private group are consumers.

4. The system of claim 1, wherein substantially all the private participants are businesses, and wherein the listings of items for sale are managed at least in part by a business participating in the private group.

5. The system of claim 1, wherein the at least one module is further to extend an invitation to a marketplace participant to join at least one of the private groups.

6. The system of claim 1, wherein the at least one module is further to provide at least one participant safety feature in the online marketplace, and further to extend the at least one safety feature to the private participants participating in the at least one private group.

7. A computer-implemented method comprising:
hosting an online marketplace for marketplace participants;
allowing a segmentation of the marketplace into at least one private group for private participants; and
receiving listings of items for sale exclusively to the private participants.

8. The method of claim 7, wherein substantially all the private participants are consumers, and wherein the listings of items for sale are managed at least in part by a consumer participating in the private group.

9. The method of claim 7, wherein the listings of items for sale are managed at least in part by a business participating in the private group, and wherein substantially all remaining private participants in the private group are consumers.

10. The method of claim 7, wherein substantially all the private participants are businesses, and wherein the listings of items for sale are managed at least in part by a business participating in the private group.

11. The method of claim 7, further comprising extending an invitation to a marketplace participant to join at least one of the private groups.

12. The method of claim 7, further comprising providing at least one participant safety feature in the online marketplace, and extending the at least one safety feature to the private participants participating in the at least one private group.

13. A non-transitory machine readable medium, including instructions, which when performed by a machine, cause the machine to perform operations including:
hosting an online marketplace for marketplace participants;
allowing a segmentation of the marketplace into at least one private group for private participants; and
receiving listings of items for sale exclusively to the private participants.

14. The non-transitory machine readable medium of claim 13, wherein substantially all the private participants are consumers, and wherein the listings of items for sale are managed at least in part by a consumer participating in the private group.

15. The non-transitory machine readable medium of claim 13, wherein the listings of items for sale are managed at least in part by a business participating in the private group, and wherein substantially all remaining private participants in the private group are consumers.

16. The non-transitory machine readable medium of claim 13, wherein substantially all the private participants are businesses, and wherein the listings of items for sale are managed at least in part by a business participating in the private group.

17. The non-transitory machine readable medium of claim 13, wherein the operations further comprise extending an invitation to a marketplace participant to join at least one of the private groups.

18. The non-transitory machine readable medium of claim 13, further comprising providing at least one participant safety feature in the online marketplace, and extending the at least one safety feature to the private participants participating in the at least one private group.
